(19) United States
(12) Patent Application Publication
(10) Pub. No.: US 2011/0049972 A1
(43) Pub. Date: Mar. 3, 2011

(54) STROKE SIMULATOR AND BRAKE CONTROL APPARATUS

(75) Inventor: Takahiro Tsuji, Toyota-shi (JP)

(73) Assignee: Toyota Jidosha Kabushiki Kaisha, Toyota-shi (JP)

(21) Appl. No.: 12/714,567

(22) Filed: Mar. 1, 2010

Related U.S. Application Data
(63) Continuation of application No. PCT/JP2009/004308, filed on Sep. 1, 2009.

(51) Int. Cl. B60T 13/12; B60T 13/18

(52) U.S. Cl. 303/10; 60/552

(57) ABSTRACT

A stroke simulator generates a reaction force in response to the operation of a brake pedal. The stroke simulator includes a stroke simulator housing, a stroke simulator piston, disposed slidably in the housing, which divides the interior of the stroke simulator housing into a first volumetric chamber and a second volumetric chamber, a stroke simulator spring, disposed in the second volumetric chamber, which generates a reaction force in response to the operation of the brake pedal by elastic deformation caused by the sliding of the stroke simulator piston, and a first supply port and a second supply port, provided for the first volumetric chamber and the second volumetric chamber, respectively, which are capable of supplying the operating oil pressure into the respective volumetric chambers when the brake pedal is operated.

### BACKGROUND OF THE INVENTION

1. Field of the Invention

The present invention relates to a stroke simulator capable of generating a reaction force in response to the operation of a brake pedal and a brake control apparatus using the stroke simulator.

2. Description of the Related Art

Stroke simulators have hitherto been used in brake control apparatuses in order to generate a reaction force in response to the operation of a brake pedal (See Patent Documents 1 and 2, for instance).

### PRIOR ART DOCUMENTS

### [Patent Documents]

[Patent Document 1] Japanese Patent Application Publication No. 2007-203859.

[Patent Document 2] Japanese Patent Application Publication No. 2006-248473.

With conventional stroke simulators, however, it is necessary to raise the spring constant of a spring provided in the stroke simulator in order to create a desired pedal feeling counter to a high hydraulic pressure generated by a master cylinder. To make the spring constant larger, the wire diameter or the size of the spring must be made larger, which will result in a large size of the stroke simulator.

### SUMMARY OF THE INVENTION

The present invention has been made in view of the foregoing circumstances, and a purpose thereof is to provide a small stroke simulator and a brake control apparatus using such a stroke simulator.

In order to resolve the foregoing problems, a stroke simulator according to one embodiment of the present invention is a stroke simulator operative to generate a reaction force in response to an operation of a brake pedal, and the stroke simulator comprises: a housing; a piston disposed slidably in the housing, the piston dividing the interior of the housing into a first volumetric chamber and a second volumetric chamber; an elastic member disposed in at least one of the first volumetric chamber and the second volumetric chamber, the elastic member generating a reaction force in response to the operation of the brake pedal by elastic deformation caused by the sliding of the piston; and supply ports one each provided for the first volumetric chamber and the second volumetric chamber, the supply ports capable of supplying an operating oil pressure into the respective volumetric chambers when the brake pedal is operated.

By employing this embodiment, the operating oil pressure is supplied to both the first volumetric chamber and the second volumetric chamber when the brake pedal is stepped on. Thus, it suffices if the elastic member can be deformed elastically against a difference between the force received by a pressure receiving face that faces the first volumetric chamber of the piston and the force received by a pressure receiving face that faces the second volumetric chamber thereof. This allows the use of a stroke simulator spring of small wire diameter and small size, so that the stroke simulator can be made smaller.

The piston may comprise the area of a pressure receiving face on a side of the first volumetric chamber and the area of a pressure receiving face on a side of the second chamber which differs from the area of a pressure receiving face on a side of the first volumetric chamber. In such a case, even when the pressure is the same in both the first volumetric chamber and the second volumetric chamber, the piston can be slid because the area of the first volumetric chamber side pressure receiving face differs from the area of the second volumetric chamber side pressure receiving face. As a result, the reaction force in response to the operation of the brake pedal can be generated.

Another embodiment of the present invention relates to a brake control apparatus. This apparatus comprises: a wheel cylinder configured to apply a braking force to a wheel by supplying an operating oil pressure thereto; a brake pedal operated by a driver; a master cylinder configured to send out an operating oil pressurized in response to a press of the brake pedal; a master cut valve configured to shut off a flow between the master cylinder and the wheel cylinder; and a stroke simulator disposed between the master cylinder and the master cut valve, the stroke simulator generating a reaction force in response to an operation of the brake pedal. The stroke simulator includes: a housing; a piston disposed slidably in the housing, the piston dividing the interior of the housing into a first volumetric chamber and a second volumetric chamber; an elastic member disposed in at least one of the first volumetric chamber and the second volumetric chamber, the elastic member generating a reaction force in response to the operation of the brake pedal by elastic deformation caused by the sliding of the piston; and supply ports one each provided for the first volumetric chamber and the second volumetric chamber, the supply ports capable of supplying the operating oil pressure into the respective volumetric chambers when the brake pedal is operated.

By employing this embodiment, the operating oil pressure is supplied from the master cylinder to both the first volumetric chamber and the second volumetric chamber of the stroke simulator when the brake pedal is pressed. Thus, it suffices if the elastic member of the stroke simulator can be deformed elastically against a difference between the force received by a pressure receiving face that faces the first volumetric chamber of the piston and the force received by a pressure receiving face that faces the second volumetric chamber thereof. This allows the use of an elastic member of small wire diameter and small size, so that a brake control apparatus using a small stroke simulator can be achieved.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is an illustration showing a brake control apparatus according to an embodiment of the present invention;

FIG. 2 is an illustration for explaining the structures of a master cylinder and a stroke simulator in greater detail;

FIG. 3 is an illustration for explaining operations of a brake control apparatus according to an embodiment of the present invention;

FIG. 4 is an illustration for explaining relational expressions pertaining to a brake control apparatus according to an embodiment of the present invention.

### DETAILED DESCRIPTION OF THE INVENTION

Hereinbelow, a detailed description will be given of best modes for carrying out the invention with reference to the drawings.

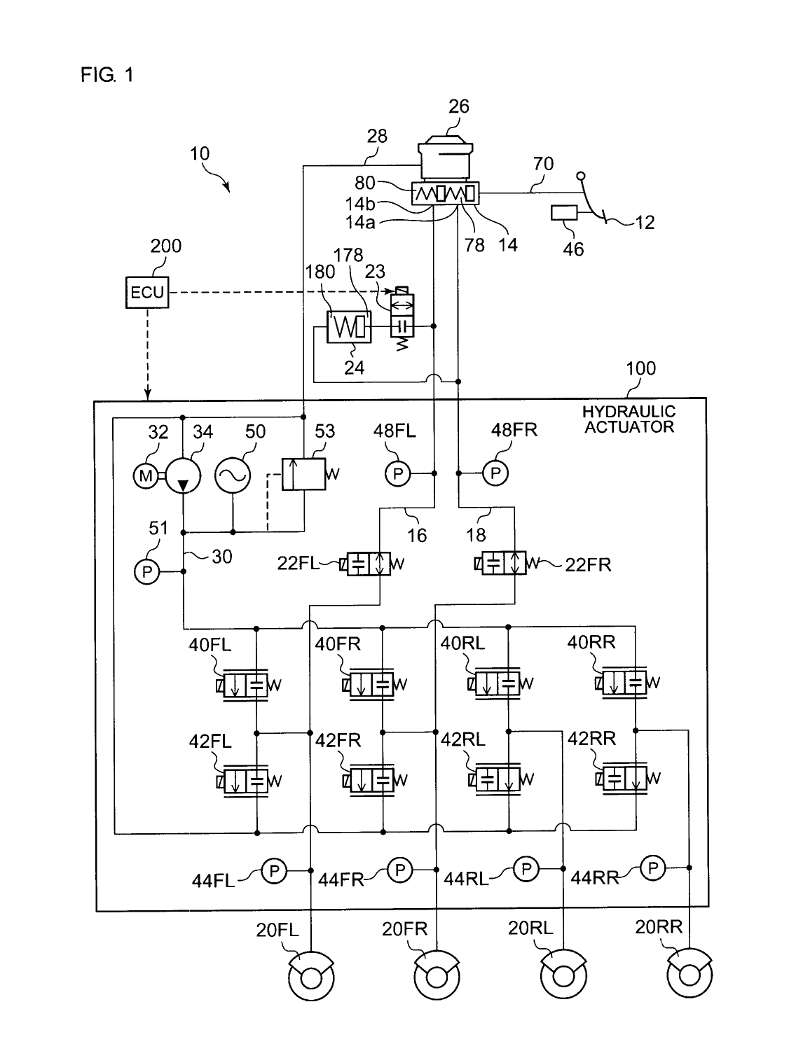

FIG. 1 is a diagram showing a brake control apparatus 10 according to an embodiment of the present invention. The brake control apparatus 10 shown in FIG. 1 constitutes an electronically controlled brake system for a vehicle and controls optimally the brakes of the four wheels of the vehicle based on the amount of operation of a brake pedal 12 stepped on by a driver.

The brake pedal 12 is connected to a master cylinder 14 that sends out an operating oil pressurized in response to pedal operation by the driver. The brake pedal 12 is provided with a stroke sensor 46 for detecting a pedal stroke caused by the pedal operation.

The master cylinder 14 has a first master hydraulic pressure chamber 78 and a second master hydraulic pressure chamber 80. A reservoir tank 26 for storing the operating oil is connected above the master cylinder 14. The first master hydraulic chamber 78 and the second master hydraulic chamber 80 communicate with the reservoir tank 26 when the pressing of the brake pedal 12 is released.

A brake hydraulic control pipe 18 for a right front wheel is connected to the first master hydraulic pressure chamber 78 of the master cylinder 14 via a first output port 14a. The brake hydraulic control pipe 18 is connected to a wheel cylinder 20FR, for the right front wheel, which applies a braking force to the right front wheel. Also, a brake hydraulic control pipe 16 for a left front wheel is connected to the second master hydraulic pressure chamber 80 of the master cylinder 14 via a second output port 14b. The brake hydraulic control pipe 16 is connected to a wheel cylinder 20FL, for

the left front wheel, which applies a braking force to the left front wheel.

A right master cut valve 22FR is provided at a midway point of the brake hydraulic control pipe 18 for the right front wheel, whereas a left master cut valve 22FL is provided at a midway point of the brake hydraulic control pipe 16 for the left front wheel. Both the right master cut valve 22FR and the left master cut valve 22FL are normally-opened type electromagnetic on-off valves which are opened when power is not being applied and closed when power is on.

A right master pressure sensor 48FR for detecting a master cylinder pressure on a right front wheel side is provided at a midway point of the brake hydraulic control pipe 18 for the right front wheel, whereas a left master pressure sensor 48FL for measuring a master cylinder pressure on a left front wheel side is provided at a midway point of the brake hydraulic control pipe 16 for the left front wheel.

In the brake control apparatus 10, when the brake pedal 12 is stepped on by the driver, the stroke sensor 46 detects the amount of pedal operation. However, it is also possible to obtain the pedal operating force (pedaling force) applied to the brake pedal 12 from the master cylinder pressure detected by the right master pressure sensor 48FR and the left master pressure sensor 48FL. Therefore, it is preferable from a failsafe point of view that the master cylinder pressure is monitored by the two pressure sensors 48FR and 48FL by assuming the failure of the stroke sensor 46. Hereinbelow, the right master pressure sensor 48FR and the left master pressure sensor 48FL will be generically referred to as “master pressure sensor 48” or “master pressure sensors 48” as appropriate.

The stroke simulator 24 creates a reaction force corresponding to a pressing operation of the brake pedal 12 by the driver. The stroke simulator 24 has two volumetric chambers which are a first volumetric chamber 178 and a second volumetric chamber 180

The first volumetric chamber 178 of the stroke simulator 24 is connected, upstream of the left master cut valve 22FL, to the brake hydraulic control pipe 16 for the left front wheel. That is, the first volumetric chamber 178 of the stroke simulator 24 is connected to the second master hydraulic pressure chamber 80 of the master cylinder 14 via the second output port 14b. Also, the second volumetric chamber 180 of the stroke simulator 24 is connected, upstream of the right master cut valve 22FR, to the brake hydraulic control pipe 18 for the right front wheel. That is, the second volumetric chamber 180 of the stroke simulator 24 is connected to the first master hydraulic pressure chamber 78 of the master cylinder 14 via the first output port 14a.

A simulator cut valve 23 is provided midway in a flow passage connecting the second master hydraulic pressure chamber 80 of the master cylinder and the first volumetric chamber 178 of the stroke simulator 24. The simulator cut valve 23 is a normally-closed type electromagnetic on-off valve which is opened when power is on and closed when power is not being applied (e.g., when abnormality occurs).

Connected to the reservoir tank 26 is one end of a hydraulic supply-exhaust pipe 28, and the other end of the hydraulic supply-exhaust pipe 28 is connected to a suction opening of an oil pump 34 which is driven by a motor 32. A discharge opening of the oil pump 34 is connected to a high-pressure pipe 30, and connected to this high-pressure pipe 30 are an accumulator 50 and a relief valve 53. In the present embodiment, the oil pump 34 to be used is a reciprocating pump equipped with two or more pistons (not shown) which are each reciprocated by the motor 32. The accumulator 50 to be used is one that stores the pressure energy of operating oil converted into a pressure energy of a filler gas such as nitrogen.

The accumulator 50 stores the operating oil whose pressure is raised to about 14 to 22 MPa, for instance, by the oil pump 34. A valve outlet of the relief valve 53 is connected to the hydraulic supply-exhaust pipe 28. If the pressure of the operating oil in the accumulator 50 rises abnormally to about 25 MPa, for instance, the relief valve 53 will open to return the high-pressure operating oil to the hydraulic supply-exhaust pipe 28. Further, an accumulator pressure sensor 51, which detects the exit pressure of the accumulator 50, namely, the pressure of operating oil in the accumulator 50, is provided on the high-pressure pipe 30. These components, such as the motor 32, the oil pump 34 and the accumulator 50, function as hydraulic power sources capable of delivering the operating oil pressurized by the supply of power independently from the operation of the brake pedal 12.

And the high-pressure pipe 30 is connected to the wheel cylinder 20FR for the right front wheel, the wheel cylinder 20FL for the left front wheel, the wheel cylinder 2ORR for the right rear wheel, and the wheel cylinder 2ORL for the left rear wheel via pressure increasing valves 40FR, 40FL, 40RR and 40RL, respectively. Hereinbelow, the wheel cylinders 20FR to 20RL will be generically referred to as “wheel cylinder 20” or “wheel cylinders 20” as appropriate. Also, the pressure increasing valves 40FR to 40RL will hereinbelow be generically referred to as “pressure increasing valve 40” or “pressure increasing valves 40” as appropriate. The pressure increasing valves 40 are each a normally-closed type electromagnetic flow control valve (linear valve) which is closed when power is not being applied and which is used to increase the pressure of the wheel cylinder as needed. Note that a disk brake unit is provided for each wheel of a vehicle (not shown) and a braking force is generated by pressing a brake pad against a disk by the operation of the wheel cylinder 20.

The wheel cylinder 20FR for the right front wheel and the wheel cylinder 20FL for the left front wheel are connected to the hydraulic supply-exhaust pipe 28 via pressure reducing valves 42FR and 42FL, respectively. The pressure reducing valves 42FR and 42FL are normally-closed type electromagnetic flow control valves (linear valves) which are used to reduce the pressure of the wheel cylinders 20FR and 20FL as needed. On the other hand, the wheel cylinder 20RR for the right rear wheel and the wheel cylinder 20RL for the left rear wheel are connected to the hydraulic supply-exhaust pipe 28 via the hydraulic supply-exhaust pipe 28 via pressure reducing valves 42RR and 42RL, respectively. Hereinbelow, the pressure reducing valves 42FR to 43RL will be generically referred to as “pressure reducing valve 42” or “pressure reducing valves 42” as appropriate.

Wheel cylinder pressure sensors 44FR, 44FL, 44RR and 44RL, which detect the wheel cylinder pressure, or the pressure of operating oil working on their corresponding wheel cylinders 20, are disposed in the vicinity of the wheel cylinders 20FR to 20RL for the right front wheel, the left front wheel, the right rear wheel and the left rear wheel, respectively. Hereinbelow, the wheel cylinder pressure sensors 44FR to 44RL will be generically referred to as “wheel cylinder pressure sensor 44” or “wheel cylinder pressure sensors 44” as appropriate.

The above-described right master cut valve 22FR, left master cut valve 22FL, pressure increasing valves 40FR to 44RL, pressure reducing valves 42FR to 42RL, oil pump 34, accumulator 50 and the like constitute a hydraulic actuator 100. The hydraulic actuator 100 is controlled by an electronic control unit (hereinafter referred to as “ECU”) 200.

The ECU 200 functions as a means for controlling the pressures of the wheel cylinders in the wheel cylinders 20FR to 20RL. The ECU 200 includes a CPU performing various arithmetic processings, a ROM for storing various control programs, a RAM used as a work area for data storage and program execution, nonvolatile memories such as a backup RAM capable of holding memory contents in the event of a stoppage of the engine, an I/O interface, an A/D converter for retrieving the signals after analog signals inputted from various sensors and the like have been converted into digital signals, a counting timer, and so forth.

Electrically connected to the ECU 200 are various actuator-type components containing the hydraulic actuators 100 such as the above-described right master cut valve 22FR, left master cut valve 22FL, simulator cut valve 23, pressure increasing valves 40FR to 44RL and pressure reducing valves 42FR to 42RL.

Also, electrically connected to the ECU 200 are various sensor- and switch-type components that output signals used for the control. That is, the signals indicating the pressures of the wheel cylinders in the wheel cylinders 20FR to 20RL are inputted to the ECU 200 from the wheel cylinder pressure sensors 44FR to 44RL.

Also, the signal indicating a pedal stroke of the brake pedal 12 is inputted to the ECU 200 from the stroke sensor 46. The signals indicating the pressures of the master cylinders are inputted o the ECU 200 from the right master pressure sensor 48FR and the left master pressure sensor 48FL. The signal indicating the pressure of the accumulator is inputted to the ECU 200 from the accumulator pressure sensor 51.

Further, though not shown, the signal indicating the wheel speed of each wheel is inputted to the ECU 200 from a wheel speed sensor provided for each wheel. Also, the signal indicating a yaw rate is inputted to the ECU 200 from a yaw rate sensor, and the signal indicating the steering angle of a steering wheel is inputted to the ECU 200 from a steering angle sensor.

In the brake control apparatus 10 configured as above, when the brake pedal 12 is stepped on, the ECU 200 calculates a target deceleration of a vehicle from the pedal stroke and the master cylinder pressure indicating an actuating quantity (e.g., pressing level) of the brake pedal 12. Then the ECU 200 evaluates a target hydraulic pressure, which is a target value of the wheel cylinder pressure of each wheel, in accordance with the thus calculated deceleration. Then the ECU 200 controls the opening degree of the pressure increasing valves 40 and the pressure reducing valves 42 in such a manner that the wheel cylinder pressure of each wheel is equal to the target hydraulic pressure.

On the other hand, the right master cut valve 27FR and the left master cut valve 27FL at this time are set in a closed state, whereas the simulator cut value 23 is set in an open state. As a result, the operating oil sent out from the master cylinder 14 as the brake pedal 12 is pressed by the driver will flow into the stroke simulator 24. This will create a pedal reaction force in response to the pedaling force 12 of the brake pedal 12.

If the accumulator pressure is less than a lower limit of control range, the ECU 200 will raise the accumulator pressure by driving the oil pump 34. If the accumulator pressure is within the control range, the driving of the oil pump 34 will be stopped.

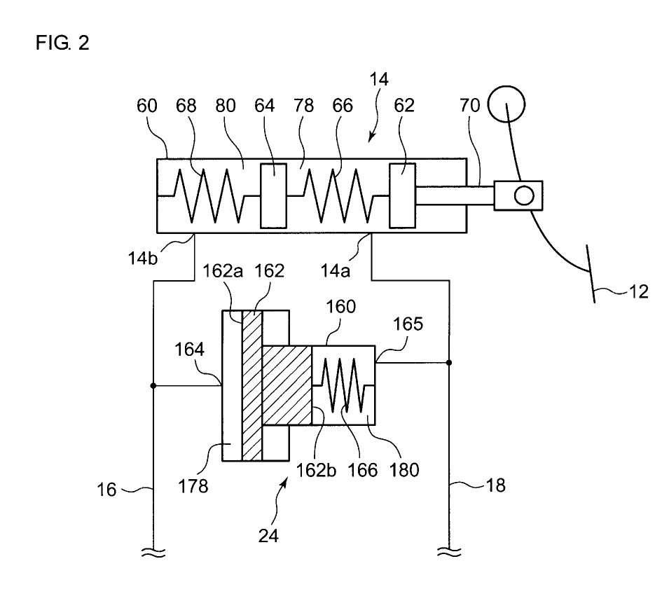

FIG. 2 is an illustration for explaining the structures of a master cylinder 14 and a stroke simulator 24 in greater detail. The master cylinder 14 includes a master housing 60, a first master piston 62, and a second master piston 64.

The master cylinder 14 has the first master piston 62 slidably housed in the master housing 60. Further, inside the master housing 60, the second master piston 64 is housed slidably in a position forward of the first master piston 62. With the two pistons inserted in the master housing 60 as described above, a first master hydraulic pressure chamber 78 is formed between the first master piston 62 and the second master piston 64, and a second master hydraulic pressure chamber 80 is formed between the second master piston 64 and the bottom of the master housing 60. It should be noted that in this patent specification, the term “forward” refers to the direction in which the first master piston 62 moves when the brake pedal 12 is stepped on, and the term “backward” refers to the direction in which the first master piston 62 moves when the brake pedal 12 returns to a predetermined initial position after the stepping-on is released.

Disposed at the backward end of the first master piston 62 is a piston rod 70 which connects the first master piston 62 with the brake pedal 12. Also, a first master spring 66 is disposed at a predetermined mounting load between the first master piston 62 and the second master piston 64, and a second master spring 68 is disposed at a predetermined mounting load between the second master piston 64 and the bottom of the master housing 60.

A first output port 14a of the master cylinder 14 communicates with the first master hydraulic pressure chamber 78, and a brake hydraulic control pipe 18 for the right front wheel is connected to the first output port 14a. A second output port 14b of the master cylinder 14 communicates with the second master hydraulic pressure chamber 80, and a brake hydraulic control pipe 16 for the left front wheel is connected to the second output port 14b.

The stroke simulator 24 includes a stroke simulator housing 160, a stroke simulator piston 162, and a stroke simulator spring 166.

The stroke simulator piston 162 is slidably housed in the stroke simulator housing 160. The stroke simulator piston 162 divides the interior of the stroke simulator housing 160 into a first volumetric chamber 178 and a second volumetric chamber 180. Inside the second volumetric chamber 180, the stroke simulator spring 166 is provided in such a manner as to bias the stroke simulator piston 162 toward the first volumetric chamber 178. In other words, the stroke simulator spring 166 is provided to bias the stroke simulator piston 162 in such a direction as to reduce the volume of the first volumetric chamber 178. The stroke simulator spring 166 generates a reaction force in response to the operation of the brake pedal 12 by undergoing elastic deformation caused by the sliding of the stroke simulator piston 162.

The stroke simulator piston 162 is such that there is a difference between the area of a first volumetric chamber side pressure receiving face 162a facing the first volumetric chamber 178 and the area of a second volumetric chamber side pressure receiving face 162b facing the second volumetric chamber 180. In the present embodiment, as shown in FIG. 2, the stroke simulator piston 162 is formed such that the area of the first volumetric chamber side pressure receiving face 162a is larger than the area of the second volumetric chamber side pressure receiving face 162b.

The first volumetric chamber 178 and second volumetric chamber 180 of the stroke simulator 24 are provided with a first supply port 164 and a second supply port 165, respectively, for supplying the operating oil pressures into the respective volumetric chambers.

The first supply port 164 of the first volumetric chamber 178 is connected to the brake hydraulic control pipe 16 in a position upstream of the left master cut valve. That is, the first volumetric chamber 178 of the stroke simulator 24 is connected to the second master hydraulic pressure chamber 80 of the master cylinder 14 via the first supply port 164. Note that the simulator cut valve, which is to be provided between the brake hydraulic control pipe 18 and the stroke simulator 24, is not shown in FIG. 2.

The second supply port 165 of the second volumetric chamber 180 is connected to the brake hydraulic control pipe 18 in a position upstream of the right master cut valve. That is, the second volumetric chamber 180 of the stroke simulator 24 is connected to the first master hydraulic pressure chamber 78 of the master cylinder 14 via the second supply port 165.

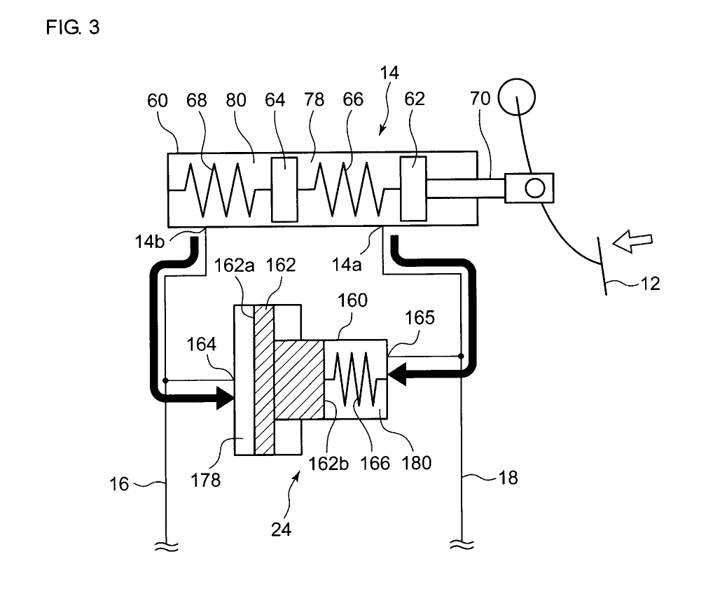

FIG. 3 is an illustration for explaining operations of a brake control apparatus according to the present embodiment. When the brake pedal 12 is stepped on by the driver, the right master cut valve and the left master cut valve, as described already, are closed and the simulator cut valve is opened. Accordingly, the pressing of the brake pedal 12 by the driver causes the operating oil pressure sent out from the second master hydraulic pressure chamber 80 of the master cylinder 14 to be supplied to the first volumetric chamber 178 of the stroke simulator 24 via the first supply port 164.

The supply of the operating oil pressure increases the volume of the first volumetric chamber 178, and the stroke simulator piston 162 moves in such a manner as to reduce the volume of the second volumetric chamber 180. As a result, the stroke simulator spring 166 is deformed elastically, and a reaction force in response to it is applied to the brake pedal 12.

Further, according to the present embodiment, the second volumetric chamber 180 of the stroke simulator 24 is connected to the first master hydraulic pressure chamber 78 of the master cylinder 14, so that when the brake pedal 12 is pressed, the operating oil pressure is also supplied to the second volumetric chamber 180. This operating oil pressure supplied to the second volumetric chamber 180 generates such a force as to push the stroke simulator piston 162 toward the first volumetric chamber 178.

Note here that in the present embodiment as described above, the stroke simulator 24 is formed such that the area of the first volumetric chamber side pressure receiving face 162a is larger than the area of the second volumetric chamber side pressure receiving face 162b. Accordingly, even when the same operating pressure has occurred in the first master hydraulic pressure chamber 78 and the second master hydraulic pressure chamber 80 of the master cylinder 14, a difference can be created between the force the first volumetric chamber side pressure receiving face 162a receives from the hydraulic oil and the force the second volumetric chamber side pressure receiving face 162b receives from it. Thus, a reaction force due to the elastic deformation of the stroke simulator spring 166 can be obtained.

With a conventional stroke simulator, the first volumetric chamber 178 is connected to the second master hydraulic pressure chamber 80 of the master cylinder 14 whereas the second volumetric chamber 180 is connected to a reservoir tank or the like. In such a case, it is necessary to set the spring constant of the stroke simulator spring 166 high in order to achieve a desired pedal feeling counter to the high master cylinder pressure applied to the first volumetric chamber 178 when the brake pedal 12 is pressed. To make the spring constant larger, the wire diameter or the size of the spring must be made larger, which will result in a large size of the stroke simulator.

In contrast to that, in a brake control apparatus 10 according to the present embodiment, the second volumetric chamber 180 of the stroke simulator 24 is connected to the first master hydraulic pressure chamber 78 of the master cylinder 14, so that when the brake pedal 12 is pressed, the operating oil pressure is also supplied to the second volumetric chamber 180. And this generates such a force as to push the stroke simulator piston 162 toward the first volumetric chamber 178. It can be considered that this force assists the biasing force of the stroke simulator spring 166. Hence, the stroke simulator spring 166 is acceptable if it can be deformed elastically against a difference between the force the first volumetric chamber side pressure receiving face 162a receives from the operating oil and the force the second volumetric chamber side pressure receiving face 162b receives from the operating oil. This allows the use of a stroke simulator spring 166 of small wire diameter and small size, so that the stroke simulator 24 can be made smaller.

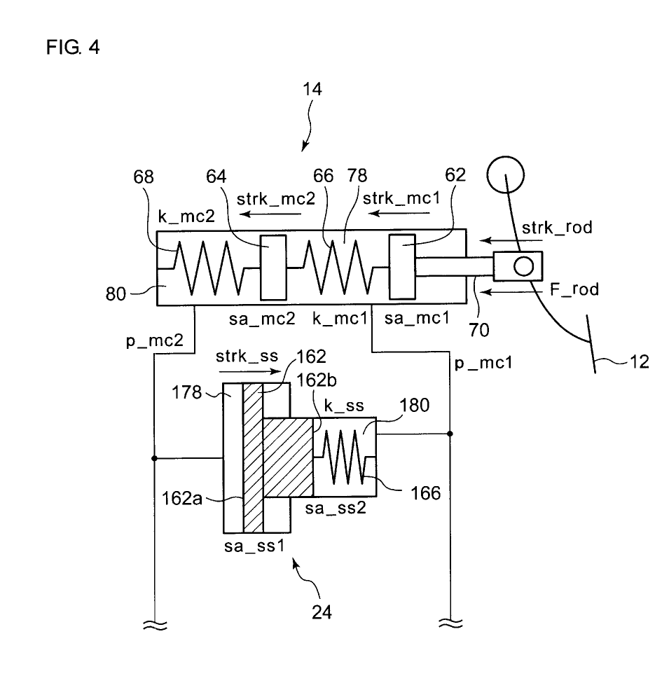

FIG. 4 is an illustration for explaining relational expressions pertaining to the brake control apparatus 10 according to the present embodiment. Here, the stroke of the piston rod 70 is denoted as strk_rod, and the force inputted to the piston rod 70 as F rod. Also, as regards the master cylinder 14, the spring constant of the first master spring 66 is denoted as k_mc1, the spring constant of the second master spring 68 as k_mc2, the sectional area of the first master hydraulic pressure chamber 78 as sa_mc1, the sectional area of the second master hydraulic pressure chamber 80 as sa_mc2, the hydraulic pressure of the first master hydraulic pressure chamber 78 as p_mc1, and the hydraulic pressure of the second master hydraulic pressure chamber 80 as p_mc2. Also, as regards the stroke simulator 24, the spring constant of the stroke simulator spring 166 is denoted as k_ss, the area of the first volumetric chamber side pressure receiving face 162a as sa_ss1, the area of the second volumetric chamber side pressure receiving face 162b as sa_ss2, and the stroke of the stroke simulator piston 162 as strk_ss.

The following relational expressions (1) to (6) hold for the master cylinder 14 and the stroke simulator 24 shown in FIG. 4.

(1) Expression of equilibrium of forces at the stroke simulator piston 162:

sa_ss1×p_mc2=sa_ss2×p_mc1+k_ss×strk_ss

(2) Expression of equilibrium of forces at the first master piston 62:

k_mc1×strk_mc1+p_mc1×sa_mc1=F_rod

(3) Expression of equilibrium of forces at the second master piston 64:

k_mc2×strk_mc2+p_mc2×sa_mc2=p_mc1×sa_mc2+k_mc1×strk_mc1

(4) Expression of equilibrium of the amount of operating oil in the first master hydraulic pressure chamber 78:

strk_mc1×sa_mc1=−strk_ss×sa_ss2

strk_mc1=−strk_ss×sa_ss2/sa_mc1

(5) Expression of equilibrium of the amount of operating oil in the second master hydraulic pressure chamber 80:

strk_mc2×sa_mc2=strk_ss×sa_ss1

strk_mc2=strk_ss×sa_ss1/sa_mc2

(6) Relational expression of stroke:

strk_rod=strk_mc1+strk_mc2

The first term sa_ss2×p_mc1 of the right-hand side of expression (1) is the term which does not exist with a conventional stroke simulator. That is, the expression of equilibrium of forces at the stroke simulator piston of the conventional stroke simulator will be as expressed in expression (7) below.

sa_ss1×p_mc2=k_ss×strk_ss (7)

The stroke strk ss of the stroke simulator piston 162 has the limits, so that when the hydraulic pressure p_mc2 in the second master hydraulic pressure chamber 80 is high, the spring constant k_ss of the stroke simulator spring 166 must be made large to satisfy expression (7).

Expression (8) below is one with the first term of the right-hand side of expression (1) transpose to the left-hand side.

sa_ss1×p_mc2−sa_ss2×p_mc1=k_ss×strk_ss (8)

In the present embodiment, it is so arranged that the operating oil pressure is supplied from the first master hydraulic pressure chamber 78 to the second volumetric chamber 180. As a result, a force (sa_ss2×p_mc1) is generated that reduces the force (sa_ss1×p_mc2) which pushes the stroke simulator piston 162 toward the second volumetric chamber 180. The occurrence of this force allows the spring constant k_ss of the stroke simulator spring 166 to become smaller. In other words, a small stroke simulator spring 166 can be used.

The expressions (1) to (6) may be rearranged into expression (9) below.

F_rod==strk_rod/(sa_ss1/sa_mc2−sa_ss2/sa_mc1)×{k_mc1×sa_ss2/sa_mc1+(k_{mc1×sa}_ss2/sa_mc1−k_mc2×sa_ss1/sa_mc2+k_ss/sa_ss1×sa_mc2)/(sa_ss2/sa_ss1×sa_mc2−sa_mc2)×sa_mc1} (9)

As shown by the expression (9), the relationship between the stroke strk rod of the piston rod 70 and the force F rod inputted to the piston rod 70 can be expressed by another design parameters (kmc1, kmc2, etc.), which indicate the feasibility of the brake control apparatus 10 according to the present embodiment.

The present invention has been described by referring to the embodiments and such description is for illustrative purposes only. It is understood by those skilled in the art that any arbitrary combinations of the embodiments and any arbitrary combinations of the constituting elements and processes could be developed as modifications and that such modifications are also within the scope of the present invention.

In the above-described embodiment, a single stroke simulator spring 166 is used. However, one having multistage spring characteristics or nonlinear spring characteristics may be used if an improved feeling of brake operation by the driver is to be achieved.

Also, in above-described embodiment, the second master hydraulic pressure chamber 80 is connected to the first volumetric chamber 178, and the first master hydraulic pressure chamber 78 is connected to the second volumetric chamber 180. However, the arrangement may be such that the first master hydraulic pressure chamber 78 is connected to the first volumetric chamber 178, and the second master hydraulic pressure chamber 80 is connected to the second volumetric chamber 180.

What is claimed is:

1. A stroke simulator operative to generate a reaction force in response to an operation of a brake pedal, the stroke simulator comprising:
a housing;
a piston disposed slidably in the housing, the piston dividing the interior of the housing into a first volumetric chamber and a second volumetric chamber;
an elastic member disposed in at least one of the first volumetric chamber and the second volumetric chamber, the elastic member generating a reaction force in response to the operation of the brake pedal by elastic deformation caused by the sliding of the piston; and
supply ports one each provided for the first volumetric chamber and the second volumetric chamber, the supply ports capable of supplying an operating oil pressure into the respective volumetric chambers when the brake pedal is operated.

2. A stroke simulator according to claim 1, wherein the piston comprising the area of a pressure receiving face on a side of the first volumetric chamber and the area of a pressure receiving face on a side of the second chamber which differs from the area of a pressure receiving face on a side of the first volumetric chamber.

3. A brake control apparatus comprising:
a wheel cylinder configured to apply a braking force to a wheel by supplying an operating oil pressure thereto;
a brake pedal operated by a driver;
a master cylinder configured to send out the operating oil pressurized in response to a press of the brake pedal;
a master cut valve configured to shut off a flow between the master cylinder and the wheel cylinder; and
a stroke simulator disposed between the master cylinder and the master cut valve, the stroke simulator generating a reaction force in response to an operation of the brake pedal,
the stroke simulator including:
a housing;
a piston disposed slidably in the housing, the piston dividing the interior of the housing into a first volumetric chamber and a second volumetric chamber;
an elastic member disposed in at least one of the first volumetric chamber and the second volumetric chamber, the elastic member generating a reaction force in response to the operation of the brake pedal by elastic deformation caused by the sliding of the piston; and
supply ports one each provided for the first volumetric chamber and the second volumetric chamber, the supply ports capable of supplying the operating oil pressure into the respective volumetric chambers when the brake pedal is operated.

4. A brake control apparatus according to claim 3, wherein the piston is such that the area of a pressure receiving face on a side of the first volumetric chamber differs from the area of a pressure receiving face on a side of the second volumetric chamber.
